(19) United States
(12) Patent Application Publication
(10) Pub. No.: US 2024/0427857 A1
(43) Pub. Date: Dec. 26, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Akiko MOCHIZUKI, Kanagawa (JP)

(73) Assignee: FUJIFILM Business Innovation Corp., Tokyo (JP)

(21) Appl. No.: 18/525,965

(22) Filed: Dec. 1, 2023

(30) Foreign Application Priority Data
Jun. 23, 2023 (JP) 2023-103753

(51) Int. Cl. G06F 21/31

(52) U.S. Cl. CPC G06F 21/31

(57) ABSTRACT

An information processing system includes one or more processors configured to: receive authentication information for an authentication service for a user who uses a real apparatus; and cause a function corresponding to an authentication system defined by the received authentication information to be able to be used on the real apparatus.

### CROSS-REFERENCE TO RELATED APPLICATIONS

This application is based on and claims priority under 35 USC 119 from Japanese Patent Application No. 2023-103753 filed Jun. 23, 2023.

### BACKGROUND

### (i) Technical Field

The present disclosure relates to an information processing system, an information processing method, and a non-transitory computer readable medium.

### (ii) Related Art

In Japanese Patent No. 5821903, a technique regarding cloud computing is disclosed. In this technique, a cloud server includes a target apparatus setting unit that sets a specified information apparatus to a target apparatus use of which is restricted, a constraint setting unit that sets, according to settings input, at least one authorized account that is allowed to log in and to use the information apparatus and a constraint in use of the information apparatus for the authorized account, and a use restriction unit that permits a user who has logged in with the authorized account to use the information apparatus without exceeding the constraint set for the authorized account.

### SUMMARY

In the case where a user is temporarily allowed to use a real apparatus, a function of the real apparatus that is able to be used by the user is not restricted. Thus, security risk may arise.

Aspects of non-limiting embodiments of the present disclosure relate to improving security, compared to a case where functions of a real apparatus are able to be used uniformly irrespective of which authentication system authentication is performed by.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: receive authentication information for an authentication service for a user who uses a real apparatus; and cause a function corresponding to an authentication system defined by the received authentication information to be able to be used on the real apparatus.

### BRIEF DESCRIPTION OF THE DRAWINGS

Exemplary embodiments of the present disclosure will be described in detail based on the following figures, wherein:

FIG. 1 is a block diagram illustrating a system configuration of a service providing system;

FIG. 2 is a block diagram illustrating a configuration of a principal section of an electrical system of an MFP;

FIG. 3 is a block diagram illustrating a configuration of a principal section of an electrical system of a controller of the MFP;

FIG. 4 is a block diagram illustrating a configuration of a principal section of an electrical system of a DS;

FIG. 5 is a block diagram illustrating a configuration of a principal section of an electrical system of a controller of the DS;

FIG. 6 is a block diagram illustrating a functional configuration of the DS;

FIG. 7 is a sequence diagram illustrating processing performed when the MFP of the service providing system is used;

FIG. 8 is a display example of authentication services; and

FIG. 9 is a flowchart illustrating a process performed when the MFP is used.

### DETAILED DESCRIPTION

### Exemplary Embodiments

A service providing system using an information processing system according to an exemplary embodiment of the present disclosure will be described with reference to drawings. Substantially the same component elements and substantially the same processing will be denoted by the same reference signs, and repetitive description may be omitted. Furthermore, unless otherwise stated herein, the number of each of component elements is not limited to one, and the number of each of the component elements may be two or more.

### [Service Providing System]

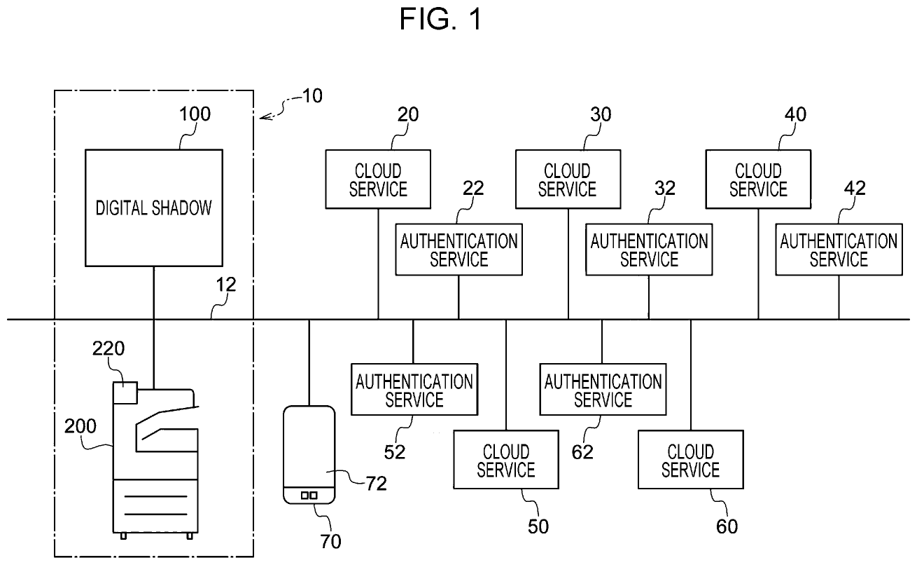

FIG. 1 is a diagram illustrating an example of the system configuration of a service providing system 10 using an information processing system according to an exemplary embodiment. The service providing system 10 includes a digital shadow (hereinafter, referred to as a “DS”) 100 as an example of the information processing system and a multifunction peripheral (hereinafter, referred to as an “MFP”) 200 as an example of a physical real apparatus and is a system that provides services using the MFP 200 to users 90A and 90B. The DS 100 and the MFP 200 are connected to the Internet 12 as an example of a communication line. The user 90A is an internal user belonging to a company, which will be described later, and the user 90B is an external user not belonging to the company. Hereinafter, in the case where the users 90A and 90B do not need to be distinguished from each other, the users 90A and 90B may be simply referred to as users 90.

A plurality of cloud services 20, 30, 40, 50, and 60 and authentication systems 22, 32, 42, 52, and 62 are connected to the DS 100 of the service providing system 10 via the Internet 12. Furthermore, a terminal device 70 that is carried by a user 90 is connected to the DS 100 via the Internet 12. Hereinafter, in the case where the cloud services 20, 30, 40, 50, and 60 and the authentication systems 22, 32, 42, 52, and 62 do not need to be distinguished from each other, the cloud services 20, 30, 40, 50, and 60 and the authentication systems 22, 32, 42, 52, and 62 may be simply referred to as “cloud services” and “authentication services” without reference signs.

The terminal device 70 in this exemplary embodiment is a portable information device operated by the user 90 who uses the MFP 200 of the service providing system 10. Specifically, the terminal device 70 is an information device, such as a laptop personal computer, a smartphone, a tablet terminal, or a wearable terminal, having a data input/output function, a data processing function, a communication function, and the like. The terminal device 70 may be an information device, such as a non-portable personal computer, that is used in a fixed position. Furthermore, although the users 90 have individual terminal devices 70, these terminal devices 70 will be simply referred to as terminal devices 70 without any distinction between them.

In this exemplary embodiment, the MFP 200 is a so-called digital multifunction peripheral including an image forming device, an image scanner, and the like. Specifically, the MFP 200 is an apparatus that performs, for example, data processing for images in response to instructions from the users 90. The data processing for images includes, for example, a scan function for reading, as image data, contents recorded on a recording medium such as paper, a copy function for reproducing, as an image, contents of image data on paper acquired by the scan function onto a recording medium, and a print function for forming, as an image, image data specified in advance by a user 90 onto a paper medium.

The DS 100 as an example of the information processing system is a virtual apparatus for the MFP 200 as an example of the physical real apparatus provided on a cloud server. As described above, the DS 100 is connected to the MFP 200 and the terminal device 70 via the Internet 12. Furthermore, as described above, the DS 100 is connected to the plurality of cloud services 20, 30, 40, 50, and 60 via the Internet 12. The terminal device 70 is also connected to the cloud services 20, 30, 40, 50, and 60 via the Internet 12.

In this exemplary embodiment, basic functions of the MFP 200, such as the copy function, are processed inside the MFP 200. For example, an extension to access the outside via the Internet 12 is processed by the DS 100.

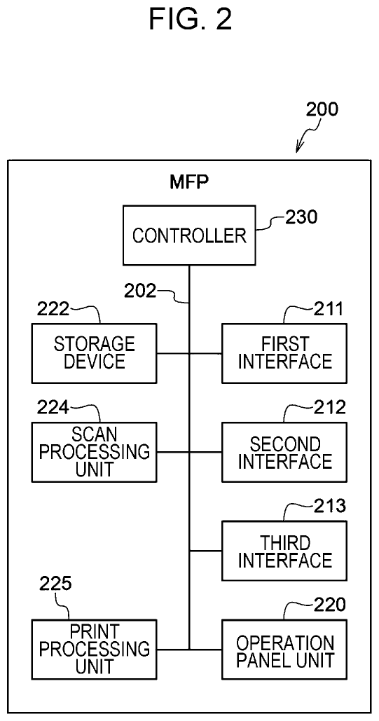

FIG. 2 is a block diagram illustrating a configuration of a principal section of an electrical system of the MFP 200.

The MFP 200 includes a first interface 211, a second interface 212, a third interface 213, an operation panel unit 220 (see FIG. 1), a storage device 222, a scan processing unit 224, a print processing unit 226, and a controller 230. These component elements are electrically connected to one another by a system bus 202.

The first interface 211 is an interface for connecting the MFP 200 to the Internet 12 (see FIG. 1). The second interface 212 is an interface for connecting the MFP 200 to the terminal device 70 (see FIG. 1) via Wi-Fi Direct (registered trademark). The third interface 213 is an interface for connecting the MFP 200 to the terminal device 70 (see FIG. 1) via short range wireless communication such as near field communication (NFC).

An operation screen allowing the user 90 to operate the MFP 200 is displayed on the operation panel unit 220 (see FIG. 1). Display contents of the operation screen displayed on the operation panel unit 220 are generated by the DS 100 (see FIG. 1). The storage device 222 includes a hard disk drive (HDD), a solid state drive (SSD), and the like. Various data, application programs, and the like are stored in the storage device 222. The scan processing unit 224 performs processing regarding the scan function of the MFP 200. The print processing unit 226 performs processing regarding the print function of the MFP 200.

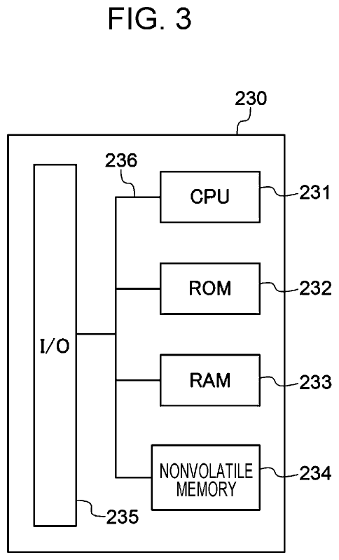

As illustrated in FIG. 3, the controller 230 includes a central processing unit (CPU) 231 that performs processing in the MFP 200, a read only memory (ROM) 232 that stores various programs, a random access memory (RAM) 233 that is used as a temporary work area for the CPU 231, a nonvolatile memory 234, and an input/output interface (I/O) 235. The CPU 231, the ROM 232, the RAM 233, the nonvolatile memory 234, and the I/O 235 are connected to one another via a bus 236. The first interface 211, the second interface 212, the third interface 213, the operation panel unit 220, the storage device 222, the scan processing unit 224, and the print processing unit 226 described above are electrically connected to the I/O 235 via the system bus 202 (see FIG. 2).

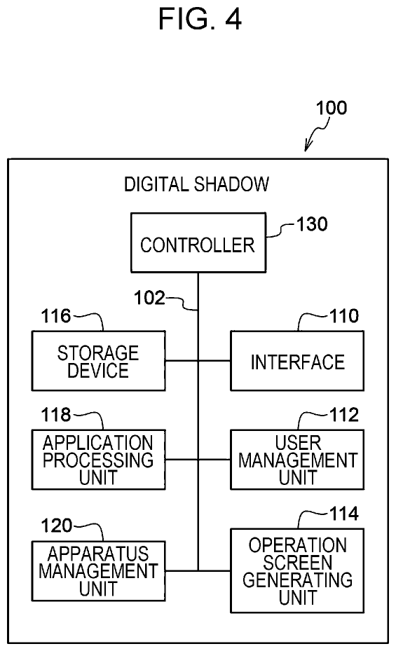

FIG. 4 is a block diagram illustrating a configuration of a principal section of an electrical system of the DS 100.

The DS 100 includes an interface 110, a user management unit 112, an operation screen generating unit 114, a storage device 116, an application processing unit 118, an apparatus management unit 120, and a controller 130. These component elements are electrically connected to one another via a system bus 102.

The interface 110 is an interface for connecting the DS 100 to the Internet 12 (see FIG. 1). The user management unit 112 connects to the authentication systems 22, 32, 42, 52, and 62, which will be described later, to perform user authentication and determine whether or not to permit each user to use corresponding services. The operation screen generating unit 114 generates display contents of an operation screen displayed on the operation panel unit 220 of the MFP 200 (see FIG. 2). The storage device 116 includes an HDD, an SSD, and the like. Various data, application programs, and the like are stored in the storage device 116. The application processing unit 118 performs processing of applications that perform various types of processing. The application processing unit 118 may complete processing in the DS 100 or may perform processing in cooperation with the cloud services 20, 30, 40, 50, and 60 (see FIG. 1). The apparatus management unit 120 connects to the MFP 200 (see FIGS. 1 and 2) to cause the MFP 200 to perform various types of processing and acquires the status of the MFP 200.

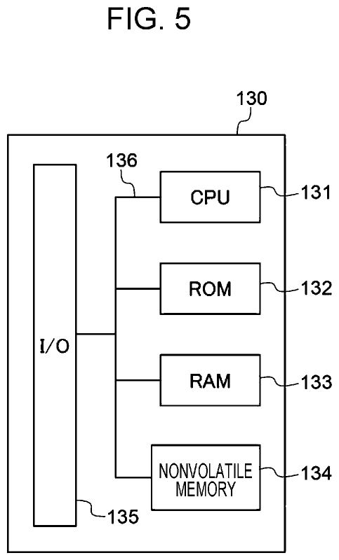

As illustrated in FIG. 5, the controller 130 includes a CPU 131 as an example of a processor that performs processing in the DS 100, a ROM 132 that stores various programs, a RAM 133 that is used as a temporary work area for the CPU 131, a nonvolatile memory 134, and an input/output interface (I/O) 135. The CPU 131, the ROM 132, the RAM 133, the nonvolatile memory 134, and the I/O 135 are connected to one another via a bus 136. The interface 110, the user management unit 112, the operation screen generating unit 114, the storage device 116, the application processing unit 118, and the apparatus management unit 120 described above are electrically connected to the I/O 135 via the system bus 102 (see FIG. 4).

### [Functional Configuration]

Next, a functional configuration of the DS 100 will be described.

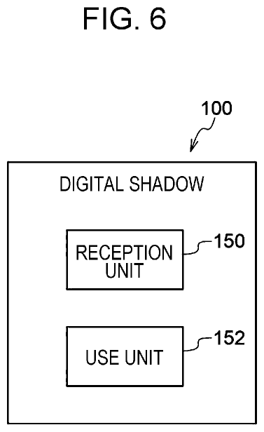

FIG. 6 is a block diagram illustrating an example of the functional configuration of the DS 100.

The DS 100 includes a reception unit 150 and a use unit 152. The reception unit 150 receives a token for an authentication service for the user 90 who uses the MFP 200 (see FIG. 1). The use unit 152 causes a function corresponding to an authentication system set by a received token to be able to be used on the MFP 200 (see FIG. 1). The functional configuration is implemented when the CPU 131 of the DS 100 reads and executes a program stored in, for example, the ROM 132 (see FIG. 5).

### [Sequence]

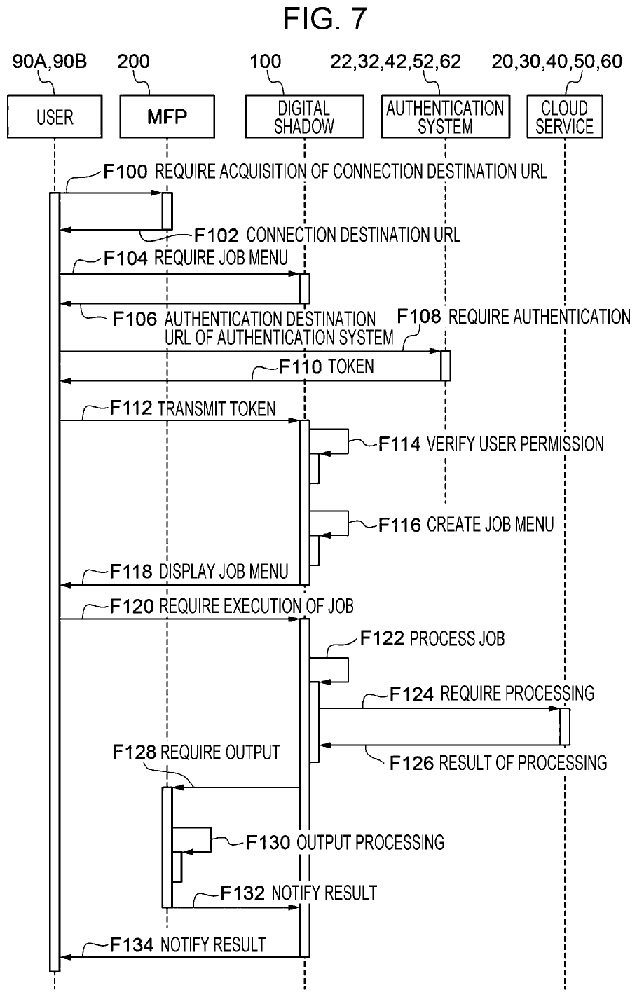

Next, an example of a method in which the user 90 uses, using the terminal device 70, the MFP 200 of the service providing system 10 illustrated in FIG. 1 will be described with reference to a sequence diagram of FIG. 7. In this example, the internal user 90A is an employee of Company XX in which the MFP 200 is installed, and the user 90B is an external user who visits Company XX. Furthermore, connection between the DS 100 and the MFP 200 and connection between the DS 100 and the terminal device 70 are implemented via the Internet 12 (see FIG. 1).

First, a case where the internal user 90A uses the MFP 200 will be described. The internal user 90A is able to use all the functions of the MFP 200. The functions of the MFP 200 include use of the cloud services 20, 30, 40, 50, and 60 (see FIG. 1). Since the internal user 90A is able to use all the functions, the internal user 90A is able to use all the cloud services 20, 30, 40, 50, and 60.

The terminal device 70 of the internal user 90A connects to the MFP 200 to acquire a connection destination URL as an example of connection information about the DS 100 (step F100). The terminal device 70 may connect to the MFP 200 in any connection method. For example, the terminal device 70 connects to the MFP 200 through short range wireless communication such as a universal serial bus (USB), Wi-Fi Direct, or NFC. The MFP 200 transmits the connection destination URL of the DS 100 stored in the storage device 222 (step F102).

The connection destination URL of the DS 100 may be acquired without connection to the MFP 200. For example, the connection destination URL may be acquired by reading QR code (registered trademark) displayed on, for example, the operation panel unit 220 of the MFP 200. Alternatively, since the user 90A is an employee of Company XX, the connection destination URL may be registered in advance in the terminal device 70.

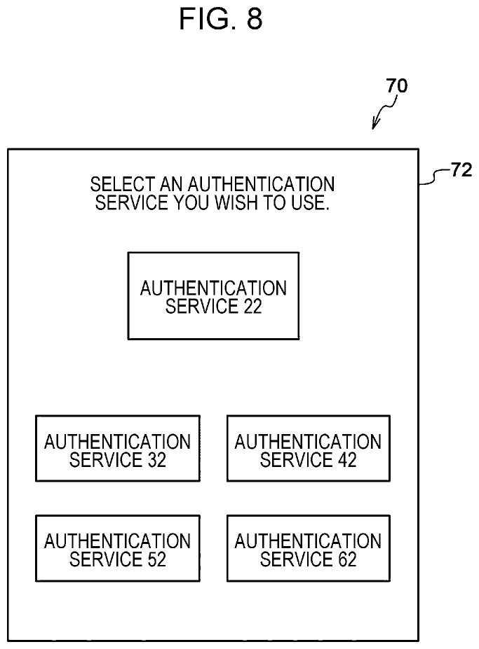

The user 90A connects, using the connection destination URL, to the DS 100, and requires a job menu (step F104). In response to this, the DS 100 requires the terminal device 70 to perform user authentication, and transmits authentication destination URLs of the authentication systems 22, 32, 42, 52, and 62 (see FIG. 1) that are able to be used in the service providing system 10 according to this exemplary embodiment (step F106). In this exemplary embodiment, the authentication destination URLs of the authentication systems 22, 32, 42, 52, and 62 are presented in the form of a Web page as a UI screen. The UI screen (see FIG. 8) is displayed on a screen 72 of the terminal device 70 (see FIG. 1). The authentication system 22 is an authentication system used for Company XX. When the user 90A selects one of the authentication systems 22, 32, 42, 52, and 62 displayed on the UI screen, the terminal device 70 is connected to the authentication destination URL of a service corresponding to the selected authentication system.

In this example, the internal user 90A selects the authentication system 22 for Company XX in which the internal user 90A has their own account. The internal user 90A logs into the authentication system 22 to require authentication (step F108), and the terminal device 70 acquires a token TA as an example of authentication information (step F110). The authentication system 22 in this exemplary embodiment is a system dedicated to Company XX. Only the internal user 90A, who belongs to Company XX, and users 90 authorized by Company XX are able to use the authentication system 22.

The user 90A transmits, from the terminal device 70, the token TA to the DS 100 and requires the DS 100 to log in using the token TA (step F112). The DS 100 receives the transmitted token TA. The DS 100 verifies that the received token TA has been issued by the authentication system 22 for Company XX and the user 90A is an employee of Company XX (step F114).

In the case where it is determined, based on a result of the verification, that the user 90A is an employee of Company XX, the DS 100 permits the user 90A to use functions of the MFP 200 corresponding to the authentication system 22 defined by the token TA, that is, all the functions in this example.

Then, the DS 100 creates a menu of jobs using all the functions of the MFP 200 that are able to be used (step F116). The DS 100 transmits the created job menu to the terminal device 70, and the job menu is displayed on the screen 72 of the terminal device 70 (see FIG. 1) (step F118). The user 90A requires the DS 100 to perform processing of a job selected on the job menu (step F120). The job menu is a list of items of functions that are able to be used on the MFP 200 and displayed on the screen 72 of the terminal device 70 (see FIG. 1).

The DS 100 receives the request for the job and processes the job (step F122). At this time, in the case where a service using any one of the cloud services 20, 30, 40, 50, and 60 is requested, the DS 100 connects to the corresponding cloud service to require the processing (step F124). For example, the DS 100 reads and acquires data stored in the cloud service 20 and creates text based on the acquired data.

As with the authentication system 22, the cloud service 20 is a service dedicated to Company XX. Thus, the DS 100 does not need the token TA to log into the cloud service 20. However, to log into the cloud services 30, 40, 50, or 60 not dedicated to Company XX, the token TA may be transmitted so that the DS 100 is able to log in.

The cloud service 20 performs the processing of the job and transmits an execution result to the DS 100 (step F126). The DS 100 requires the MFP 200 to output the job (step F128). The MFP 200 performs output (step F130). The MFP 200 notifies the DS 100 of an output result (step F132). Then, the DS 100 transmits the output result to the terminal device 70, and the output result is displayed on the terminal device 70 (step F134).

Next, a case where the external user 90B uses the MFP 200 will be described. A case where the user 90B performs printing using the MFP 200 in Company XX where the user 90B visits will be described. The external user 90B is able to use only part of the functions of the MFP 200.

Since the processing up to step F106 in which the DS 100 requires the terminal device 70 to perform user authentication is the same between the internal user 90A and the external user 90B, description of the processing up to step F106 will be omitted.

Since the external user 90B is not able to log into the authentication system 22 for Company XX, the external user 90B logs into any one of the external authentication systems 32, 42, 52, and 62. In this example, the external user 90B is able to log into the authentication system 62. The authentication system 62 is a system used by the cloud service 60, and the authentication system 62 is able to access only the cloud service 60.

The user 90B selects, on the UI screen (see FIG. 8), the authentication system 62 in which the user 90B has their own account, logs into the authentication system 62, and requires authentication (step F108). Then, the terminal device 70 acquires a token TB (step F110).

The user 90B transmits, from the terminal device 70, the token TB to the DS 100 and requires the DS 100 to log in (step F112). The DS 100 receives the transmitted token TB. The DS 100 verifies that the received token TB has been issued by the authentication system 62 and the user 90B is an external user and is able to use the cloud service 60 (step F114).

In the case where it is verified that the user 90B is an external user who is able to use the cloud service 60, the DS 100 permits the user 90B to use part of the functions of the MFP 200 corresponding to the authentication system 62 defined by the token TB. For example, the DS 100 permits the user 90B to use only the copy function of the MFP 200 and the cloud service 60. The use of the cloud service 60 that is permitted for the user 90B includes printing, using the MFP 200, of documents stored in the cloud service 60 and e-mail transmission, using an e-mail address of the cloud service 60, of documents read by the MFP 200.

Then, the DS 100 creates a menu of jobs using part of the functions of the MFP 200 that are able to be used (step F116). The DS 100 transmits the created job menu to the terminal device 70, and the job menu is displayed on the terminal device 70 (step F118). The external user 90B requires the DS 100 to perform processing of a job selected on the job menu (step F120).

The DS 100 receives the request for the job and processes the job (step F122). In the case where printing, using the MFP 200, of a document stored in the cloud service 60 is requested, the DS 100 logs into the cloud service 60 by using the token TB, and acquires the specified document.

The DS 100 requires the MFP 200 to output the job, that is, to print a document stored in the cloud service 60 (step F128). The MFP 200 performs printing (step F130). The MFP 200 notifies the DS 100 of an output result (step F132). Then, the DS 100 transmits the output result to the terminal device 70, and the output result is displayed on the terminal device 70 (step F134).

Next, a case where the external user 90B needs to pay to use the cloud service 60 will be described.

The user 90B selects, on the UI screen (see FIG. 8), the authentication system 62 in which the user 90B has their own account, logs into the authentication system 62, and requires authentication (step F108). Then, the terminal device 70 acquires a token TC (step F110). At this time, the amount of credit that is able to be used on the cloud service 60 is put on the token TC. Thus, the user 90B receives the token TC with credit.

Furthermore, the user 90B transmits, from the terminal device 70, the token TC with credit to the DS 100 and requires the DS 100 to log in (step F112). The DS 100 receives the transmitted token TC. The DS 100 verifies that the received token TC has been issued by the authentication system 62 and the user 90B is an external user and is able to use the cloud service 60 (step F114).

At this time, the DS 100 inquires of the cloud service 60 how much credit the token TC has. In the case where the credit is able to be applied to the amount of bill for a function provided by the MFP 200, the DS 100 permits the user 90B to use the function that is able to be used using the credit. Then, the DS 100 creates a menu of jobs on the MFP 200 that are able to be used using the credit (step F116). The DS 100 transmits the created job menu to the terminal device 70, and the job menu is displayed on the terminal device 70 (step F118). The external user 90B requires the DS 100 to perform processing of the job selected on the job menu (step F120).

In the processing of step F112 described above, the users 90A and 90B connect, using the terminal device 70, to the DS 100 via the Internet 12 and transmit the tokens TA, TB, and TC to the DS 100. However, the processing of step F112 is not limited to the processing described above. The users 90A and 90B may transmit the tokens TA, TB, and TC to the DS 100 via the MFP 200. Specifically, the tokens TA, TB, and TC may be transmitted from the terminal device 70 to the MFP 200 via short range wireless communication such as NFC, and the tokens TA, TB, and TC may be transmitted from the MFP 200 to the DS 100.

Furthermore, in the processing of step F118 described above, the DS 100 transmits the created job menu to the terminal device 70, and the job menu is displayed on the terminal device 70. However, the processing of step F118 is not limited to the processing described above. The job menu may be displayed on the operation panel unit 220 of the MFP 200. Similarly, in the processing of step F134 described above, the DS 100 transmits an output result to the terminal device 70, and the output result is displayed on the terminal device 70. However, the processing of step F134 is not limited to the processing described above. The output result may be displayed on the operation panel unit 220 of the MFP 200.

Hereinafter, in the case where there is no need to distinguish between the tokens TA, TB, and TC, these tokens may be simply referred to as “tokens” without reference signs.

### [Flowchart]

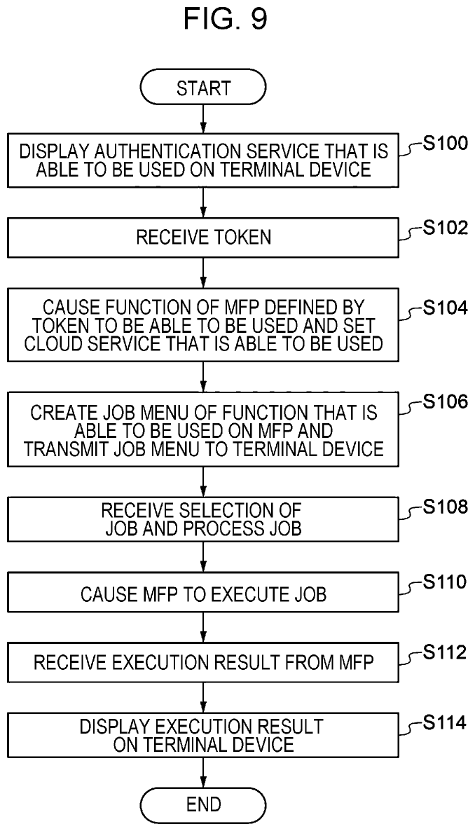

FIG. 9 is a flowchart illustrating an example of the flow of a process performed by the DS 100.

When receiving a request for a job menu from the terminal device 70, the CPU 131 of the DS 100 displays authentication services that are able to be used on the terminal device 70 in such a manner that an authentication service is able to be selected (see FIG. 8) (step S100).

The CPU 131 receives a token for the selected authentication system (step S102).

The CPU 131 causes a function corresponding to the authentication system defined by the received token to be able to be used on the MFP 200 and sets a cloud service that is able to be used in accordance with the token (step S104). In the case where a charge is required, the CPU 131 causes a function defined by charge information included in the token to be able to be used on the MFP 200.

The CPU 131 creates the menu of jobs that are able to be used on the MFP 200, and transmits the job menu to the terminal device 70 (step S106).

The CPU 131 receives selection of the job on the job menu and processes the job (step S108). At this time, part of or the entire processing of the cloud service may be performed on the cloud service.

The CPU 131 causes the MFP 200 to perform the processed job (step S110).

The CPU 131 receives a result of execution of the job from the MFP 200 (step S112). Then, the CPU 131 transmits the execution result to the terminal device 70, and the execution result is displayed on the terminal device 70 (step S114).

### <Operation>

Next, operation in an exemplary embodiment will be described.

The DS 100 sets a function that is able to be used on the MFP 200 in accordance with an authentication system defined by an acquired token. Thus, security is improved, compared to the case where functions of the MFP 200 are able to be used uniformly once authentication is completed in an authentication system.

“Security” represents so-called information security and represents ensuring confidentiality, integrity, and availability of information. Confidentiality represents ensuring the state in which only a person who is authorized to access information is able to access the information. Integrity represents ensuring the state in which information is not destroyed, falsified, or deleted. Availability represents ensuring the state in which a person who is authorized to access information is able to access the information when necessary without interruption.

In an exemplary embodiment, for example, in the case where functions of the MFP 200 are able to be used uniformly, the external user 90B is permitted to access documents, programs, and the like stored in the MFP 200. However, by setting a function that is able to be used on the MFP 200 in accordance with an authentication system defined by an acquired token, the situation mentioned above is avoided or prevented, and security is improved.

Furthermore, the DS 100 sets a cloud service that is able to be used in accordance with an authentication system defined by an acquired token. Thus, security is improved, compared to the case where cloud services are able to be used uniformly once authentication is completed in an authentication system.

Furthermore, the DS 100 displays a menu of jobs using functions that are able to be used on the MFP 200 on at least one of the terminal device 70 and the operation panel unit 220 of the MFP 200, and executes a selected job on the MFP 200. Thus, compared to the case where functions that a user 90 is not able to use and a job menu are displayed in a mixed manner, the user 90 is able to make a selection easily. In the case where a job menu is displayed on the operation panel unit 220 of the MFP 200 and the user 90 makes a selection, it is guaranteed that the user 90 who uses the MFP 200 is present near the MFP 200. Thus, security is improved.

Furthermore, the DS 100 displays a result of execution of a job on at least one of the terminal device 70 and the operation panel unit 220 of the MFP 200. Thus, the user 90 is able to check the result of execution of the job.

Furthermore, since the DS 100 sets a cloud service that is able to be used in accordance with a received token, security is improved, compared to the case where cloud services that are able to be used are set uniformly once authentication is completed in an authentication system.

Furthermore, the DS 100 is able to use, on the MFP 200, a function defined by charge information included in a received token. That is, a function requiring payment is able to be used.

Furthermore, the DS 100 receives a token that the terminal device 70 of the user 90 has received from an authentication system. Thus, compared to the case where the user 90 enters, on the operation panel unit 220 of the MFP 200, information about a token, operation is simple.

Furthermore, the DS 100 receives, via the MFP 200, a token that the terminal device 70 has acquired. Specifically, a token is transmitted from the terminal device 70 to the MFP 200 through short range wireless communication such as NFC, and the token is transmitted from the MFP 200 to the DS 100. Thus, since it is guaranteed that the user 90 who uses the MFP 200 is present near the MFP 200, security is improved compared to the case where the DS 100 receives a token directly from the terminal device 70.

Furthermore, the DS 100 displays authentication services that are able to be used on the terminal device 70 in such a manner that an authentication system is able to be selected, and acquires a token for an authentication service selected by the user 90. Thus, compared to the case where an authentication system that is able to be used is not limited, security is improved.

Since the terminal device 70 connects to the MFP 200 to acquire a connection destination URL of the DS 100, security is improved compared to the case where the connection destination URL of the DS 100 is open to the public.

### OTHERS

The technical scope of the present disclosure is not limited to the exemplary embodiments described above. Various changes or improvements may be added to the exemplary embodiments described above without departing from the gist of the present disclosure. Embodiments including the changes or improvements added thereto are also included in the technical scope of the present disclosure.

Furthermore, each of the exemplary embodiments described above does not limit the disclosure of a claim, and all the combinations of features described in the exemplary embodiments are not necessarily needed to attain advantages of the present disclosure. The exemplary embodiments described above include various stages of the disclosure, and various disclosures are extracted based on combinations of disclosed component elements. Even in the case where some component elements are removed from all the component elements disclosed in exemplary embodiments, a configuration in which the component elements are removed may be extracted as a disclosure.

Furthermore, in each of the exemplary embodiments described above, a case where various type of processing are implemented by software configuration using a computer executing a program has been described. However, the present disclosure is not limited to the case mentioned above. For example, various types of processing may be implemented by hardware configuration or a combination of hardware configuration and software configuration.

The component elements of the DS 100, the MFP 200, the terminal device 70, and the like in each of the exemplary embodiments described above are merely examples. An unnecessary part may be removed or a new component element may be added without departing from the scope of the gist of the present disclosure.

Furthermore, flows of various types of processing described in the exemplary embodiments described above are merely examples. An unnecessary step may be removed, a new step may be added, or the processing order may be changed without departing from the gist of the present disclosure.

Furthermore, although a real apparatus is the MFP 200 in each of the exemplary embodiments described above, the real apparatus is not necessarily the MFP 200. For example, a real apparatus is a shared apparatus, and a permission or other restrictions may be changed depending on users who use the real apparatus. The real apparatus may be, for example, a personal computer, a tablet, or an automatic vending machine connected and operated by a user using a terminal device.

Furthermore, although authentication information is a token in each of the exemplary embodiments described above, the authentication information is not necessarily a token. The authentication information may be, for example, an electronic ticket, a password, or the like.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
An information processing system comprising:
one or more processors configured to:
   receive authentication information for an authentication service for a user who uses a real apparatus; and
   cause a function corresponding to an authentication system defined by the received authentication information to be able to be used on the real apparatus.
(((2))
The information processing system according to (((1))), wherein the one or more processors are configured to:
display a menu of jobs using set functions that are able to be used on the real apparatus on at least one of a terminal device of the user and the real apparatus; and
cause the real apparatus to execute a job selected on the menu of jobs.
(((3)))
The information processing system according to (((1))) or (((2))), wherein the one or more processors are configured to:
receive a result of execution of the job from the real apparatus; and
display the result of execution on at least one of the terminal device and the real apparatus.
(((4)))
The information processing system according to any one of (((1))) to (((3))), wherein the one or more processors are configured to set, based on the authentication information, a cloud service that is able to be used.
(((5)))
The information processing system according to any one of (((1))) to (((4))), wherein the one or more processors are configured to cause a function defined by charge information included in the received authentication information to be able to be used on the real apparatus.
(((6)))
The information processing system according to any one of (((1))) to (((5))), wherein the one or more processors are configured to receive the authentication information that a terminal device of the user has acquired from the authentication service.
(((7)))
The information processing system according to any one of (((1))) to (((6))), wherein the one or more processors are configured to receive, via the real apparatus, the authentication information acquired by the terminal device.
(((8)))
The information processing system according to any one of (((1))) to (((7))), wherein the one or more processors are configured to:
display an authentication service that is able to be used on the terminal device in such a manner that the authentication service is able to be selected; and
acquire the authentication information for the authentication service selected by the user.
(((9)))
The information processing system according to any one of (((1))) to (((8))), wherein the one or more processors are configured to:
receive connection from the terminal device, based on connection information that the terminal device has acquired from the real apparatus; and
display an authentication service that is able to be used on the terminal device in such a manner that the authentication service is able to be selected.
(((10)))
A program for causing a computer to execute a process comprising:
receiving authentication information for an authentication service for a user who uses a real apparatus; and
causing a function corresponding to an authentication system defined by the received authentication information to be able to be used on the real apparatus.

What is claimed is:

1. An information processing system comprising:
one or more processors configured to:
receive authentication information for an authentication service for a user who uses a real apparatus; and
cause a function corresponding to an authentication system defined by the received authentication information to be able to be used on the real apparatus.

2. The information processing system according to claim 1, wherein the one or more processors are configured to:
display a menu of jobs using set functions that are able to be used on the real apparatus on at least one of a terminal device of the user and the real apparatus; and
cause the real apparatus to execute a job selected on the menu of jobs.

3. The information processing system according to claim 2, wherein the one or more processors are configured to:
receive a result of execution of the job from the real apparatus; and
display the result of execution on at least one of the terminal device and the real apparatus.

4. The information processing system according to claim 1, wherein the one or more processors are configured to set, based on the authentication information, a cloud service that is able to be used.

5. The information processing system according to claim 1, wherein the one or more processors are configured to cause a function defined by charge information included in the received authentication information to be able to be used on the real apparatus.

6. The information processing system according to claim 1, wherein the one or more processors are configured to receive the authentication information that a terminal device of the user has acquired from the authentication service.

7. The information processing system according to claim 6, wherein the one or more processors are configured to receive, via the real apparatus, the authentication information acquired by the terminal device.

8. The information processing system according to claim 6, wherein the one or more processors are configured to:
display an authentication service that is able to be used on the terminal device in such a manner that the authentication service is able to be selected; and
acquire the authentication information for the authentication service selected by the user.

9. The information processing system according to claim 7, wherein the one or more processors are configured to:
display an authentication service that is able to be used on the terminal device in such a manner that the authentication service is able to be selected; and
acquire the authentication information for the authentication service selected by the user.

10. The information processing system according to claim 8, wherein the one or more processors are configured to:
receive connection from the terminal device, based on connection information that the terminal device has acquired from the real apparatus; and
display an authentication service that is able to be used on the terminal device in such a manner that the authentication service is able to be selected.

11. The information processing system according to claim 9, wherein the one or more processors are configured to:
receive connection from the terminal device, based on connection information that the terminal device has acquired from the real apparatus; and
display an authentication service that is able to be used on the terminal device in such a manner that the authentication service is able to be selected.

12. An information processing method comprising:
receiving authentication information for an authentication service for a user who uses a real apparatus; and
causing a function corresponding to an authentication system defined by the received authentication information to be able to be used on the real apparatus.

13. A non-transitory computer readable medium storing a program causing a computer to execute a process comprising:
receiving authentication information for an authentication service for a user who uses a real apparatus; and
causing a function corresponding to an authentication system defined by the received authentication information to be able to be used on the real apparatus.
